(19) United States
(12) Patent Application Publication
(10) Pub. No.: US 2011/0180006 A1
(43) Pub. Date: Jul. 28, 2011

(54) PET / BIRD FOOD BOWL

(76) Inventor: Patrick Michael McGowan, Orlando, FL (US)

(21) Appl. No.: 12/695,159

(22) Filed: Jan. 28, 2010

(51) Int. Cl. A01K 39/00; A01K 29/00

(52) U.S. Cl. 119/61.54

(57) ABSTRACT

A food bowl for a pet or bird having a circular member and a circular bowl for holding pet food or bird seed. The bowl is located within and spaced from the circular member to provide a gap between the circular member and the bowl. Pet food or bird seed that is either pushed or scattered out of the bowl by a pet or a bird can fall down thru the gap between the circular member and the bowl to a receiving chamber where it is collected in a removable receptacle for reuse.

### BACKGROUND OF THE INVENTION

1. Field of the Invention

The present invention relates generally to pet food bowls and, more particularly to pet food bowls that help reduce the amount of food an animal scatters out of the bowl when feeding.

2. Description of Related Art

The prior art discloses many different types of bowls and containers that can be used to feed a pet. Often when a pet eats from a bowl which is on the floor, various amounts of food will be pushed out over the top of the bowl and fall on the floor. Different types of bowls and containers that are designed to reduce the amount of food that falls from a pet food bowl is known in the prior art. More specifically, by way of example, U.S. Pat. No. 7,306,112 to Shepard discloses a spill-proof container that has a bowl with an access opening for holding particulate material that is freely rotatable within the chamber of a bowl support having an access opening. The access openings of the bowl and support are aligned when the bowl and support are both in their upright orientation. When the support is tipped, the bowl, which is heavier at its bottom, remains upright. As a result, the chamber access opening rotates out of alignment with the bowl access opening, which is then covered with a part of the chamber wall.

U.S. Pat. No. 7,017,518 to Zolnierz, et al., discloses attaching a guard device to a pet feeding bowl. The guard device is a bowl shaped guard that is positioned on top of a traditional pet feeding bowl. The guard device prevents food or water from being splashed out of the feeding bowl by the pet and has a diameter that is larger than that of the feeding bowl. As such, the guard device catches drippings from the animal that would not otherwise be caught by the feeding bowl.

U.S. Pat. No. 5,97,016 to Wesenhagen discloses a feeding dish having an apron section mounted on a bowl section. The apron section presents a reentrant overhang from the lip toward the center of the bowl to direct food coming up the inside of the bowl back into the bowl.

U.S. Pat. No. 5,366,103 to Abernathy, et al., discloses a bowl having a larger diameter outer bowl, a smaller diameter inner bowl which is releasably and concentrically mounted inside the outer bowl, and an annular cover which is received around the top of the outer bowl. The inner bowl is for receiving food, and the central opening of the annular cover allows the user to remove the food from the inner bowl. If the bowl is abruptly moved to cause the liquid in the inner bowl to spill over the edge of the inner bowl, the liquid is deflected downwardly by the annular cover into the surrounding outer bowl.

U.S. Pat. No. 5,366,103 to Abulhasan discloses a divided food and water bowl centered and anchored on a flat rubber mat. The mat catches all spillages while the pet feeds.

US PreGrant Publication No. 2009/0241843 to Becattini, et. al., discloses a pet feeding system for food and water bowls having a base with one wall defining an interior space. The front section has a low portion and a high portion. To obtain food from a bowl, a pet must access the bowl thru the low portion, the pet cannot access a food bowl thru the high portion. The low portion which provides a pet with access to the bowls and has a width of between 50 degrees to 80 eighty degrees, (less than 90 degrees), and the high portion which is 2 to 3½ times the height of the low portion prevents the pet from moving its head outside of the containment system while feeding. Thus, the pet feeding system disclosed not only restricts the pet from moving his/her head while feeding, but also restricts the pet to feeding from an opening that is, at most, only 80 degrees wide. Also disclosed is a filtering tray which is located above the base for catching spilled food.

US PreGrant Publication No. 2008/0072830 to Wrigge discloses two bowls having an annular moat there between to block ants. The first bowl has a first cylindrical lower portion with an outward flare before a first cylindrical upper portion. The second bowl has a second cylindrical lower portion that receives the first bowl. The second bowl has a larger second cylindrical upper portion that provides an annular space between the second bowl and the first bowl. The annular space is filled with a liquid to keep ants from getting to the food contained inside of the first bowl.

What is needed is a new improved food bowl for a pet or bird that can reduce the amount of food that is scattered onto the floor while the pet or bird is feeding, which has a food bowl that is surrounded by and suspended within and above a food collecting chamber which can collect for subsequent reuse food that passes over the top of the food bowl.

### SUMMARY OF THE INVENTION

In an exemplary embodiment of the present invention, there is disclosed a feeding station for a pet or bird having a cylindrical member and a circular bowl for holding pet food or bird seed. The bowl is located within and spaced from the cylindrical member to provide a gap between the cylindrical member and the bowl. Pet food or bird seed that is either pushed or scattered out of the bowl by a pet or a bird can fall down thru the gap between the cylindrical member and the bowl to a receiving chamber where it is collected in a removable receptacle for reuse.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a top view of a pet feeding station in accordance with the principles of the invention;

FIG. 2 is a side view of the pet feeding station in accordance with the principles of the invention;

FIG. 3 is a sectional view along line 3-3 of the pet feeding station of FIG. 1 in accordance with the principles of the invention;

FIG. 4 is a top view of a bird feeding station in accordance with the principles of the invention;

FIG. 5 is a side view of the bird feeding station in accordance with the principles of the invention; and

FIG. 6 is a sectional view along line 6-6 of the bird feeding station of FIG. 4 in accordance with the principles of the invention.

### DESCRIPTION OF THE PREFERRED EMBODIMENT

Pets typically drop and spill their food on the floor around their food bowl. In each instance the dropped food is unsightly and can promote unpleasant odors, attract bugs and rodents, and cause the growth of mold and mildew and possibly allergies and health issues if not constantly cleaned up. In addition, dropped food on the floor may be tracked through a house by a pet as he steps on the dropped food when he walks away from the food bowl. Thus, a pet owner can end up cleaning not only around a pet's food bowl but, in addition, food that is tracked thru the house.

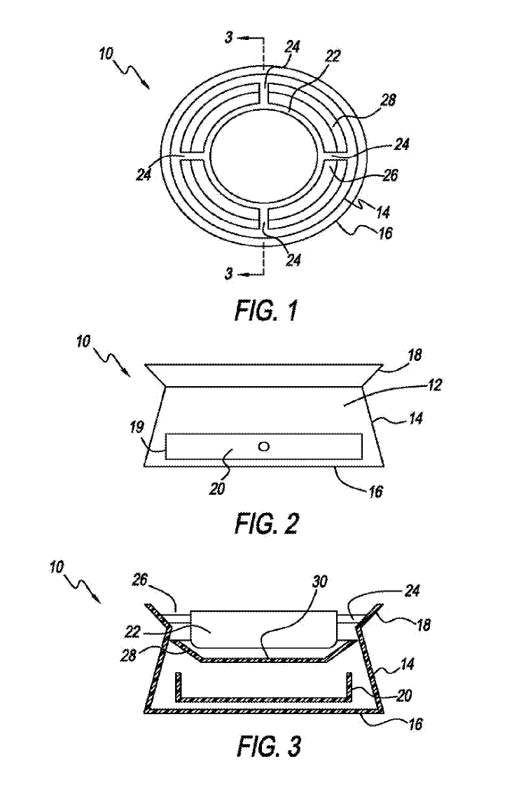

Referring to FIGS. 1, 2 and 3, there is shown a top view, a side view and a sectional view along line 3-3 of FIG. 1 of a pet food bowl 10 in accordance with the principles of the invention. The pet food bowl comprises an inverted funnel shaped member having an outward sloping side wall 14 which extends from a bottom member 16 to a flange 18 having a top edge. The flange 18 slopes outward at about forty five degrees more or less. The lower portion of the inverted funnel shaped member 12 has an opening 19 which extends less than half way around the inverted funnel shaped member 12 and can have a height of about one inch or more. The lower portion of member 12 is the drop food receiving chamber and includes a drawer 20 which can be circular, square or rectangular and which is provided for receiving dropped food. Drawer 20 can slide in and out on the bottom member, or it can be mounted on extension tracks which are attached to the bottom member. In either instance, it is preferable that the drawer be removable from the pet food bowl to allow food that is collected in the draw to be reused. The drawer can have an externally located pull knob which is used to pull the drawer out from the bottom of the funnel shaped member 12. A rubber base, not shown, can be located on the bottom of the bottom member to prevent the food bowl from being pushed around by a pet as he is eating from the bowl.

Funnel shaped member 12 can have an internal diameter at its top of about ten inches, more or less, and a total height which can vary from between five and three quarter inches to six and one quarter inches, more or less.

Centrally located within funnel shaped member 12 is a food bowl 22 which is provided for receiving food or water for a pet. Food bowl 22 can have a diameter of about eight inches more or less and a depth of about four inches. The food bowl is attached to the funnel shaped member 12 with thin support members 24. Support members 24 are attached to the outer surface of bowl 22 and the inner surface of funnel shaped member 12 and can extend down for a distance of between one quarter of an inch to three inches from the top edge of the food bowl, more or less. In the FIGS., four support members 24 are shown as being equally spaced around the bowl at the twelve, three, six and nine o'clock positions. It is understood that more or less than four support members can be provided and that the spacing between the support members does not have to be uniform.

Support members 24 provide a gap 26 of about one inch more or less between the inner wall of the funnel shaped member and the outer wall of the food bowl. Gap 26 is provided to direct food which is pushed, thrown or moved up over the top edge of the food bowl to fall down between the bowl and funnel shaped member. To prevent food from being pushed or scattered over the gap 26 and onto the floor, the top edge of the flange on the funnel shaped member is higher than the top edge of the bowl by between one quarter of an inch and three quarters of an inch, more or less.

A disc shaped member 28 having a centrally located circular opening 30 is attached at its outer edge to the inner wall of the cylindrical member at a location which can be either above or below the bottom of the food bowl. Disc shaped member 28 slopes downward at an angle of between thirty degrees and sixty degrees, more or less where forty degrees is preferable. The edge of the centrally located circular opening 30 extends below the bottom of the bowl and past the side wall of the bowl as shown in FIG. 3. The diameter of the centrally located circular opening is less than the diameter of the bowl and can be seven inches more or less. Disc shaped member 28 is provided to direct food which falls down thru the gap 26 into the circular food tray 20.

All of the various parts of the pet food bowl including funnel shaped member 12, bottom member 16, drawer 20, bowl 22, support members 24, and disc 28 can be made of a non-porous semi rigid or rigid plastic or of stainless steel, all of which can be easily cleaned.

The dimensions of the various parts of the pet food bowl can vary over a wide range and can be based on the type and/or breed of the pet for which it is being use. For example, a pet food bowl for a large pet would have different dimensions then a pet food bowl that is to be used by a small pet.

In use, the pet food bowl is placed on the floor of a home and a desired amount of food or water is placed into the bowl. The circular shape of the pet food bowl allows a pet to approach the food bowl from any angle including from a place directly in front of the pull out drawer 20, or to the left, right, or even at the rear of the drawer front to eat or drink from the bowl. While the pet is eating from the bowl, any food which is pushed over the top edge of the bowl will fall down thru the gap 26, land on the sloping side of disc 28 where the dropped food is directed to circular opening 30 and falls into the drawer 20 located in the drop food receiving chamber.

In addition, as the top edge of the flange 18 is higher than the top edge of bowl 22, food which is scattered or ejected from the bowl 22 at a low angle as the pet is eating, will hit the inside wall of the funnel shaped member or the flange, fall down through gap 26 and be directed by disc 28 into drawer 20. All food that falls into the drawer 20 can be returned to the bowl for the pet to eat. Thus, not only is food which would normally be scattered on the floor around the bowl now be in the drawer ready to be placed back into the bowl, but the need to clean up dropped food around the pet food bowl is greatly diminished and possibly eliminated.

The dimensions of the various parts of the pet food bowl can vary over a wide range and can be based on the type of pet for which it is being used. For example, the pet food bowl disclosed above can be used for all pet including dogs and/or cats. When being used for feeding cats or other small animals, whether they are tame or wild, the dimensions of the food bowl noted above can be changed to be smaller. It is understood that the dimensions noted above are not critical and that the dimensions noted above can be varied to accommodate the type and size of the pet for which it is intended and/or the location where the bowl is to be used.

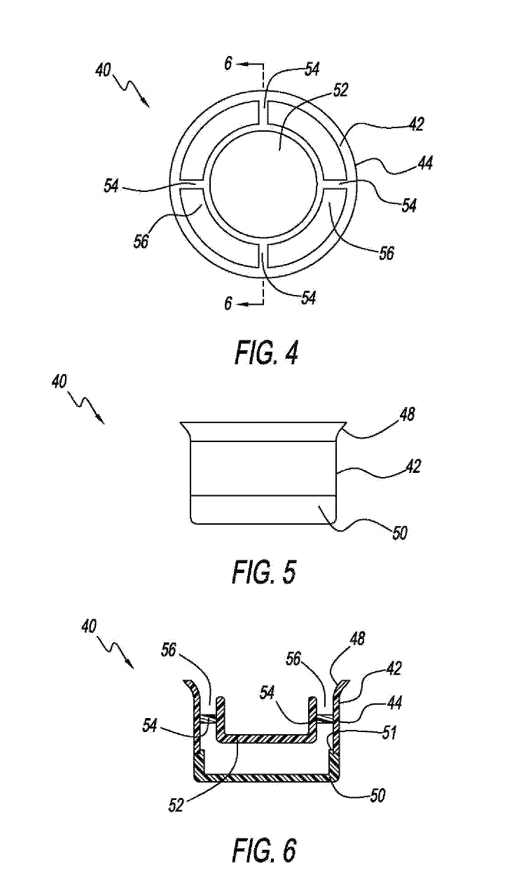

Referring to FIGS. 4, 5 and 6, there is shown a top view, a side view and a sectional view along line 6-6 of FIG. 4 of a bird food bowl 40 in accordance with the principles of the invention.

Many bird feeders have a cylindrical shaped member for holding bird seeds and a receiving tray spaced slightly away from the open bottom of the cylindrical member for holding bird seed as they drop out of the bottom of the cylindrical shaped member for supplying the bird seeds for birds to eat. As the birds eat the seeds in the tray, the seeds in the cylindrical shaped member fall down to replenish the supply of seeds for the birds. Bird feeders for wild birds are normally located on a pole or suspended from a tree limb. However, the birds, while eating the seeds can create a nuisance and a waste of seeds by scattering a considerable amount of seeds onto the ground around the bird feeder. Normally bird seed that is scattered is wasted because it falls on a hard surface such as cement or in a garden where it can grow as undesired plants and weeds. In addition, the scattered seeds can create a nuisance by attracting small rodents and squirrels.

What is needed is a bird-food catcher which is an integral part of a bird food bowl which collects the seeds which are scattered by the birds as they eat. A bird-food catcher which is an integral part of the bird food bowl allows the catcher to freely move with the wind as the bird food bowl moves and allows the collected seeds to be reused in the bird feeder. In addition, by collecting the seeds which would normally be scattered on the ground, a nuisance is avoided.

The bird food bowl 40 here disclosed comprises a cylindrical member 42 having a side wall 44 which extends from an open bottom to a top edge 48. The top edge terminates with an outward slope of about forty five degrees more or less. The lower end of cylindrical member 42 has an opening and includes internal threads 51. The lower portion of cylindrical member 42 is the drop food receiving chamber and includes a circular cup 50 which is provide for receiving scattered seeds. Circular cup 50 has external threads which engage the internal threads on the bottom of the cylindrical member.

Cylindrical member 42 can have an internal diameter of about ten inches, more or less, and a total height which can vary from between five and three quarter inches to six and one quarter inches, more or less.

Centrally located within cylindrical member 42 is a seed bowl 52 which is provided for receiving bird seeds for feeding wild birds. Seed bowl 52 can have a diameter of about eight inches more or less and a depth of about four inches, a size that is sufficient for birds to fly into and eat the seeds in the bowl while standing in the bowl. The seed bowl is attached to the cylindrical member 42 with thin support members 54. Support members 54 are attached to the outer surface of bowl 52 and the inner surface of cylindrical member 42 and can extend down for a distance of between one quarter of an inch to about three inches from the top edge of the seed bowl. In the FIGS., four support members 54 are shown as being equally spaced around the bowl at the twelve, three, six and nine o'clock positions. It is understood that more or less than four support members can be provided and that the spacing between the support members does not have to be uniform.

Support members 54 provide a gap 56 of about one inch more or less between the inner wall of the cylindrical member and the outer wall of the seed bowl. Gap 56 is provided to direct bird seeds which are thrown or scattered over the top edge of the seed bowl to fall down between the bowl and cylindrical member, not out onto the ground below. To prevent bird seeds from being thrown or scattered over the gap 56 and onto the ground below, the top edge of cylindrical member is higher than the top edge of the bowl by between one inch and three inches, more or less.

All of the various parts of the bird seed bowl can be made of a non-porous semi rigid or rigid plastic or of stainless steel which can be easily cleaned.

The dimensions of the various parts of the bird feeding station can vary over a wide range and can be based on the type of the bird for which it is being used. For example, the bird feeding bowl disclosed above can be used for all pet birds, for cage use or perch use, not just for wild birds. When being used for feeding birds which are not wild birds, the dimensions of the bird food bowl noted above can be changed to be smaller. It is understood that the dimensions noted above are not critical and that the dimensions noted above can be varied to accommodate the type and size of the birds for which it is intended and/or the location where the bowl is to be used. It is also understood that a bird food bowl for a large bird and/or wild birds will have different dimensions than a bird food bowl that is to be used for small birds, pet birds, cage use or perch use.

When being used for wild birds, the bird feeding station can be suspended between two trees with a wire to prevent squirrels from eating the bird seeds. While the birds are eating from the bowl, any food which is flung or scattered over the top edge of the bowl will hit the raised end of the cylindrical member 42 and fall down thru the gap 56 to land in the circular cup 50 at the bottom of the cylindrical member. All bird seeds that fall into the cup 50 can be returned to the bowl for the birds to eat. Thus, not only are bird seeds which would normally be scattered on the ground around the bird feeding station now ready to be placed back into the bowl, but the nuisance of having bird seeds scattered on the ground beneath the bird feeding station is virtually eliminated.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A pet food bowl for a pet or bird comprising:
a circular member having a top edge on a wall of generally uniform length; and
a bowl having a top edge on a wall of generally uniform length for holding pet food or bird seed located within and spaced from said circular member to provide a gap between the circular member and the bowl;
wherein pet food or bird seed that is urged by a pet or bird to be moved over the edge of the bowl can fall down thru the gap between the circular member and the bowl.

2. The pet food bowl of claim 1 wherein at least two support members are attached to the outer surface of the bowl and the inner surface of the circular member to provide the gap between the circular member and the bowl.

3. The pet food bowl of claim 1 wherein the top edge of the bowl is lower than the top edge of the circular member.

4. The pet food bowl of claim 3 wherein a chamber is located below the bowl for receiving pet food or bird seed that falls down thru the gap.

5. The pet food bowl of claim 4 wherein collecting means is located in said chamber for collecting pet food or bird seed that falls down thru the gap.

6. The pet food bowl of claim 5 wherein said collecting means is a drawer for receiving pet food.

7. The pet food bowl of claim 6 wherein said drawer is slidably coupled to said circular member.

8. The pet food bowl of claim 7 wherein said drawer is circular square, or rectangular.

9. The pet food bowl of claim 8 wherein a disc shaped member having a centrally located opening is attached to the circular member to direct pet food which falls down thru the gap into the drawer.

10. The pet food bowl of claim 9 wherein the disc shaped member has an outer edge attached to the inner wall of the circular member and the centrally located opening is located below the bottom of the bowl.

11. The pet food bowl of claim 10 wherein the disc shaped member slopes downward from its outer edge to its centrally located opening.

12. The pet food bowl of claim 11 wherein the disc shaped member slopes downward at an angle of between thirty degrees and sixty degrees

13. The pet food bowl of claim 11 wherein the centrally located opening in the disc shaped member is circular.

14. The pet food bowl of claim 13 wherein the centrally located opening is smaller than the bowl.

15. The pet food bowl of claim 14 wherein the bowl is circular and the diameter of the centrally located opening is less than the diameter of the bowl.

16. The pet food bowl of claim 1 wherein the circular member and bowl are made of non-porous semi rigid or rigid plastic, or of stainless steel.

17. The pet food bowl of claim 5 wherein the collecting means is a cup for receiving bird seeds.

18. The pet food bowl of claim 17 wherein the cup is coupled to the bottom of the cylindrical member with threads.

19. The pet food bowl of claim 18 wherein the top edge of the bowl is below the top edge of the circular member by a distance of between one inch and three inches.

20. The pet food bowl of claim 19 wherein the top edge of the circular member slopes outward at an angle of forty five degrees.
